(19) United States
(12) Patent Application Publication
(10) Pub. No.: US 2022/0390563 A1
(43) Pub. Date: Dec. 8, 2022

(54) METHODS AND SYSTEMS OF BEAM STEERING SYSTEM FOR LIDAR AND A FIELD PROGRAMMABLE PHASE CONTROLLER

(71) Applicant: AMAR MALLIKARJUN GAIKWAD, Bangalore (IN)

(72) Inventor: AMAR MALLIKARJUN GAIKWAD, Bangalore (IN)

(21) Appl. No.: 17/746,343

(22) Filed: May 17, 2022

Related U.S. Application Data
(60) Provisional application No. 63/189,678, filed on May 17, 2021.

(51) Int. Cl. G01S 7/481; G02F 1/295; G02F 1/025; G02B 6/12

(52) U.S. Cl. CPC G01S 7/4811; G02F 1/2955; G01S 7/4817; G02F 1/025; G02B 6/12004

(57) ABSTRACT

A metal-oxide semiconductor (MOS) structure to achieve a LIDAR beam steering, comprising: a n-number of waveguides, wherein the n-number of waveguides are connected to a laser transmitter and a receiver; a n-number phase shifters; wherein the MOS structure comprises a doping concentration of an N-drift region that is varied and a different drain-source current (IDS) to gate-source voltage (VGS) or drain-source voltage (VDS) characteristics are obtained, and wherein the IDS exists when the VGS is positive, and a magnitude of the IDS depends on a magnitude of the VGS and the VDS apart from the doping concentration of N− drift region, wherein the n-number of waveguides are connected to a laser transmitter and a receiver device, wherein the VGS is used as a control signal, wherein the VDS is set to a power supply voltage (VDD) based on at least one doping profile of the N-drift region of the MOS structure, wherein a plurality of different drain-to-source currents (IDS) are provided through the n-number of phase shifters, and wherein with a set of specified drain currents (IDS), a phase is shifted differently by the n-number of phase shifters and the beam is steered in a specified direction, and wherein only one control signal is used to achieve beam steering.

### CLAIM OF PRIORITY

This application claims priority to U.S. Provisional Patent Application No. 63/189,678 filed on 17 May 2021 and titled METHODS AND SYSTEMS OF BEAM STEERING SYSTEM FOR LIDAR AND A FIELD PROGRAMMABLE PHASE CONTROLLER. This provisional patent application is hereby incorporated by reference in its entirety.

### BACKGROUND

Legacy Phase Controller can be used to control the voltage applied to the phase shifter or by controlling the flow of current through the phase shifter may control the phase of light in the waveguide. The applied voltage or the current behaves as the control signal for the phase shifter. If there are N waveguides, there can be N such control signals to control the phase. The main processor of the Lidar or the processor controlling the Lidar can then keep track of the N control signals to achieve beam steering. There can be N digital to analog converters (DAC) to convert the digital signal from the processor to control the phase shifter. The main processor can then keep on continuously varying the N control signals to the N phase shifters to steer the beam. The beam steering process with this kind of mechanism thus consumes lots of computing cycles and in turn lots of resources. This method also involves multiple elements that are external to the main processor like the DAC's, that would need their very own auxiliary circuits. This in turn can consume power and make the overall system bulky and costly.

In some cases, if there are N waveguides, there may not be a need for N control signals to control the phase of individual waveguides. A control signal can be shared by more than one waveguide depending on the logic. In such a scenario there can be less than N DAC's. But the reduction is not substantial or else may not be able to steer the beam precisely.

For example, if there are 64 waveguides, then there can be 64 different control signals from the processor to the phase shifter. There can be 64 different digital to analog converters (DAC) to convert the digital signal from the processor to the analog signal that can be applied to the phase shifter. With 64 different DAC's the overall cost of the system is increased considerably. Also, the computing resources needed to control 64 different signals may be high and costly.

FIG. 1 illustrates an example Lidar setup 100 for determining range and other auxiliary data of its surroundings, according to some embodiments. Lidar setup 100 can be used for ranging and generating 3D point cloud data of a surrounding context.

Lidar setup 100 can include phase controller and beam steering mechanism 101. Lidar setup 100 can include laser transmitter and receiver 102. Lidar setup 100 can include waveguide 103. Lidar setup 100 can include phase shifter 104 and grating coupler 105.

It is noted that Lidar transmits light waves, which are then reflected by the surroundings. The reflected waves are detected by the Lidar and based on either the time or frequency, the Lidar gives range data and other auxiliary data. Beam steering mechanism 101 is used to steer the light waves, so that the entire surrounding data can be obtained. The Field-of-view of Beam Steering mechanism 101 decides the angle from which the data can be obtained. Beam steering mechanism 101 steers the beam in a particular Azimuth angle and Elevation angle. The azimuth and the elevation angles are varied by varying the phase of the phase shifter elements.

Lidars are of the following types:

Time-of-Flight (ToF) Lidar obtains the range data based on Time-of-Flight of the transmitted and reflected Light Pulses.

Frequency Modulated Continuous Wave (FMCW) Lidar transmits a range of frequencies and based on the reflected frequency, decides the range of the object from which the light wave was reflected.

Components and Functionality of laser transmitter and receiver 102 are now discussed. Laser transmitter transmits light waves in Near Infrared and Infrared region. The light waves are in the form of electromagnetic waves of a particular frequency. Laser receiver receives the reflected light waves.

Waveguides 103 propagate light in single Transverse Electric mode through Total Internal Reflection. There are 1 to N waveguides in the system and the spacing between each waveguide is half the wavelength (λ/2; λ is wavelength of light) of the light passing through it or less than half the wavelength.

Grating Coupler 105 is now discussed. The waveguides terminate at the grating coupler. The light from the waveguide propagates to the air through the grating coupler. Light from air can be coupled into the waveguide through the grating coupler.

Phase Shifter 104 shifts the phase of the EM wave (e.g. a light wave) passing through it. The phase shifting can be accompanied by varying the temperature, electrical properties, or liquid crystal properties. In some phase shifters the variation of temperature causes the phase to vary, while in some other, the variation of electro-optical properties causes the phase to vary and in some others the orientation of the liquid crystal varies the phase. Any one type of phase shifter can be chosen. The phase shifters can be attached to the waveguide or the waveguide itself can behave as a phase shifter. The phase shifting of each individual phase shifter is controlled by the phase controller.

Phase Controller 101 controller controls the phase of the phase shifter by controlling the magnitude of the voltage or the current applied to the phase shifter.

The Phased Array is now discussed. Waveguide 103, grating coupler 105, phase shifter 104 and the phase controller 101 form the phased array. Here, a one dimensional (1D) phased array is shown, however, a phased array can also be two dimensional (2D) with a 2D waveguide along with the phase shifter 104, the grating coupler 105, and the necessary phase controller 101.

Improvements to these systems and elements are now provided.

### SUMMARY OF THE INVENTION

A metal-oxide semiconductor (MOS) structure to achieve a LIDAR beam steering, comprising: a n-number of waveguides, wherein the n-number of waveguides are connected to a laser transmitter and a receiver; a n-number phase shifters; wherein the MOS structure comprises a doping concentration of an N-drift region that is varied and a different drain-source current (IDS) to gate-source voltage (VGS) or drain-source voltage (VDS) characteristics are obtained, and wherein the IDS exists when the VGS is positive, and a magnitude of the IDS depends on a magnitude of the VGS and the VDS apart from the doping concentration of N-drift region, wherein the n-number of waveguides are connected to a laser transmitter and a receiver device, wherein the VGS is used as a control signal, wherein the VDS is set to a power supply voltage (VDD) based on at least one doping profile of the N-drift region of the MOS structure, wherein a plurality of different drain-to-source currents (IDS) are provided through the n-number of phase shifters, and wherein with a set of specified drain currents (IDS), a phase is shifted differently by the n-number of phase shifters and the beam is steered in a specified direction, and wherein only one control signal is used to achieve beam steering.

### BRIEF DESCRIPTION OF THE DRAWINGS

The present application can be best understood by reference to the following description taken in conjunction with the accompanying figures, in which like parts may be referred to by like numerals.

FIG. 1 of the Background Section illustrates an example Lidar setup for determining range and other auxiliary data of its surroundings, according to some embodiments.

FIG. 2 illustrates an example metal-oxide semiconductor (MOS) structure, according to some embodiments.

FIG. 3 illustrates an example MOS structure, according to some embodiments. This can be a MOS capacitor or a MOS transistor.

FIG. 4 illustrates an example N⁺P MOS Capacitor, according to some embodiments.

The flat-band condition energy diagram of N⁺P MOS Capacitor is shown in FIG. 5 illustrates an example Flat-Band Condition of N⁺P MOS, according to some embodiments.

FIG. 6 illustrates an Accumulation Mode of N⁺P MOS example, according to some embodiments.

FIG. 7 illustrates an example application of an application for N⁺P MOS structure with P-body and N_{A} doping, according to some embodiments.

FIG. 8 illustrates an example P⁺N MOS Capacitor, according to some embodiments.

The flat-band condition energy diagram of P⁺N MOS Capacitor is shown in FIG. 9 illustrates an example Flat-Band Condition of P⁺N MOS, according to some embodiments.

FIG. 10 illustrates an Accumulation Mode of P⁺N MOS example, according to some embodiments.

FIG. 11 illustrates an example application of an application for P⁺N MOS structure with N-body and N_{D} doping, according to some embodiments.

FIG. 12 illustrates an example MOS structure, according to some embodiments.

FIG. 13 illustrates an example MOS structure of FIG. 12 and analytical current flow lines, according to some embodiments.

FIG. 14 illustrates an example MOS structure Drain-to-Source Current I_{DS} and Drain-to-Source Voltage V_{DS} at Different Bias of Control Voltage Gate-to-Source Voltage Vis, according to some embodiments.

FIG. 15 illustrates an example plot showing Dopant Density and Resistivity of Silicon, according to some embodiments.

FIG. 16 illustrates an example of Drift Current Density and Dopant Density N type for the MOS structure of FIG. 12, according to some embodiments.

FIG. 17 illustrates a use of MOS structure of FIG. 12 to achieve beam steering, according to some embodiments.

FIG. 18 illustrates an example use of MOS structure of FIG. 12 to achieve beam steering, according to some embodiments.

FIG. 19 illustrates an example use of MOS structure of FIG. 12 to achieve beam steering, according to some embodiment.

FIG. 20 illustrates an example alternative MOS structure, according to some embodiments.

FIG. 21 illustrates an example, drift current density and dopant density P type, according to some embodiments.

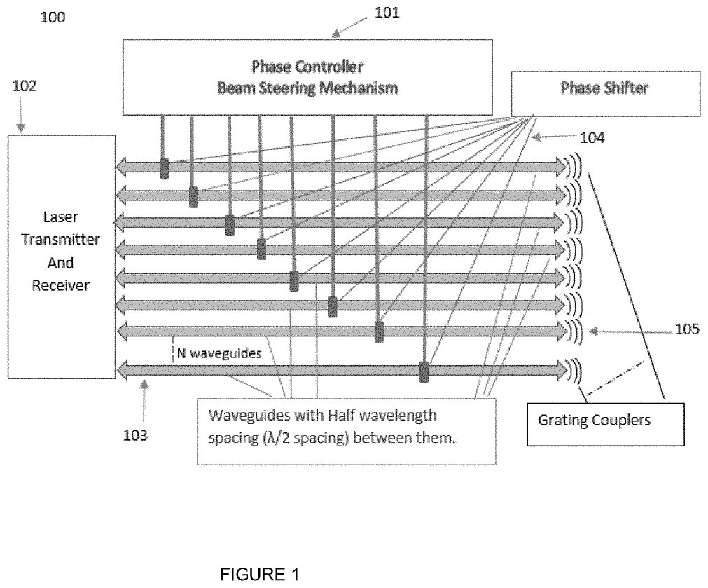

The Figures described above are a representative set and are not exhaustive with respect to embodying the invention.

### DESCRIPTION

Disclosed are a system, method, and article of manufacture for beam steering system for lidar and a field programmable phase controller. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Complementary metal-oxide-semiconductor (CMOS) is a technology used to manufacture integrated circuits. Electronic components such as microprocessors, microcontrollers, memory chips, digital sensors etc. make use of CMOS technology to achieve the stated functionality of the components. CMOS technology uses both NMOS and PMOS to achieve logic functions.

NMOS may be a N-channel metal-oxide-semiconductor. The channel refers to mode of current and N-channel means channel of electrons.

PMOS may be a P-channel metal-oxide-semiconductor. The channel refers to mode of current and P-channel means channel of holes.

Field-programmable gate array (FPGA) is an integrated circuit designed to be configured by a customer or a designer after manufacturing.

Lidar is a method for determining ranges (e.g., as a variable distance) by targeting an object with a laser and measuring the time for the reflected light to return to the receiver. Lidar can utilize visible, and/or near infrared light to image objects. A narrow laser beam can map physical features.

Metal-oxide-silicon transistor (MOS transistor) can be a type of insulated-gate field-effect transistor that is fabricated by the controlled oxidation of a semiconductor, typically silicon. The voltage of the gate terminal determines the electrical conductivity of the device; this ability to change conductivity with the amount of applied voltage can be used for amplifying or switching electronic signals.

Optical phased array (OPA) is the optical analog of a radio-wave phased array. By dynamically controlling the optical properties of a surface on a microscopic scale, it is possible to steer the direction of light beams (e.g. in an OPA transmitter), or the view direction of sensors (e.g. in an OPA receiver), without any moving parts.

Radar is a detection system that uses radio waves to determine the range, angle, or velocity of objects. A radar system consists of a transmitter producing electromagnetic waves in the radio or microwaves domain, a transmitting antenna, a receiving antenna (e.g. the same antenna is used for transmitting and receiving) and a receiver and processor to determine properties of the object(s). Radio waves (e.g. can be pulsed or continuous) from the transmitter reflect off the object and return to the receiver, giving information about the object's location and speed.

Waveguide is a structure that guides waves with minimal loss of energy by restricting the transmission of energy to one direction.

Example Beam Steering in Lidar and Radar Based on Differential Doping Using CMOS Technology

Example embodiments of a beam steering in Lidar and Radar based on differential doping using CMOS technology are now discussed. In one example, an optical phased array is used for beam steering from devices such as Lidar (e.g. Light Detection and Ranging) so that range and other auxiliary data can be obtained of the surroundings. The beam is steered by the control unit by controlling the phase of the signal through waveguides. The phase is controlled by varying the magnitude of the phase shifter attached to the waveguide. In the legacy system with N waveguides, the beam steering is achieved by controlling a similar number of control signals to the phase shifters. Keeping track of large number of control signals makes the system bulky and costly. A system is proposed that can achieve beam steering through only one control signal using complimentary metal-oxide-semiconductor (CMOS) process. The proposed system makes the beam steering process less complicated, less bulky and is cost effective when compared with the legacy system.

An example Beam Steering Mechanism is now discussed. Beam Steering is achieved by controlling the phase of each individual phase shifter. The spacing between each waveguide is λ/2 or less. So, when the light propagates in the air from the waveguide it gets superimposed by the light coming out from other waveguides. It can be thought of as light is being superimposed immediately in the air in the vicinity of the waveguides. The superimposition can be constructive or destructive. There can be propagation of light where there is constructive superimposition. There may not be any propagation of light where there is destructive superimposition. Whether the waveguide contributes to constructive superimposition or destructive superimposition is controlled by the phase of light in each individual waveguide. By varying the phase of the light in each individual waveguide, the direction where there would be constructive superimposition and where there would be destructive superimposition is controlled. Thus, the light beam coming out of waveguides can be steered by controlling the direction of constructive superimposition and destructive superimposition.

An example Phase Controller is now proposed and discussed. This phase controller eliminates the need of N separate control signals for N phase shifters to be controlled from the main processor. This in turn can eliminate the need for N separate digital to analog convertors (DAC's) and its associated auxiliary circuits. This phase controller can thus reduce the used computing resources as there may be no need to control and keep track of N control signals to the N phase shifters.

In some examples, a complimentary metal-oxide semiconductor (CMOS) fabrication process can be used to achieve phase control of N phase shifter.

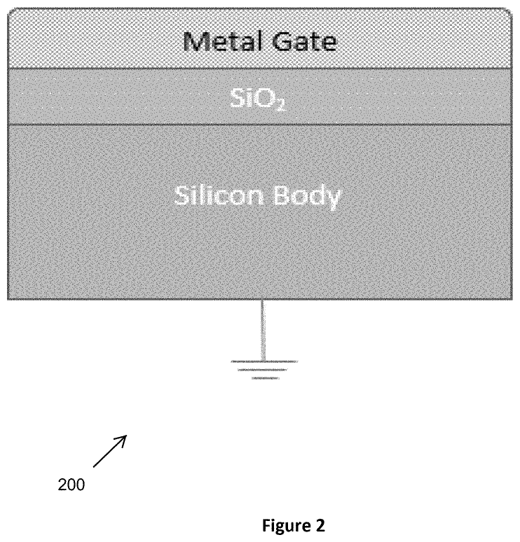

FIG. 2 illustrates an example metal-oxide semiconductor (MOS) structure, according to some embodiments. As shown, MOS Structure include a metal gate or polycrystalline gate, a silicon body or substrate and silicon dioxide in between the gate and the silicon body. N doped means it is doped with donor ions and thus has excess electrons and the doping level is defined as N_{D}. P doped means it is doped with acceptor ions and thus has excess holes and the doping level is defined as N_{A}.

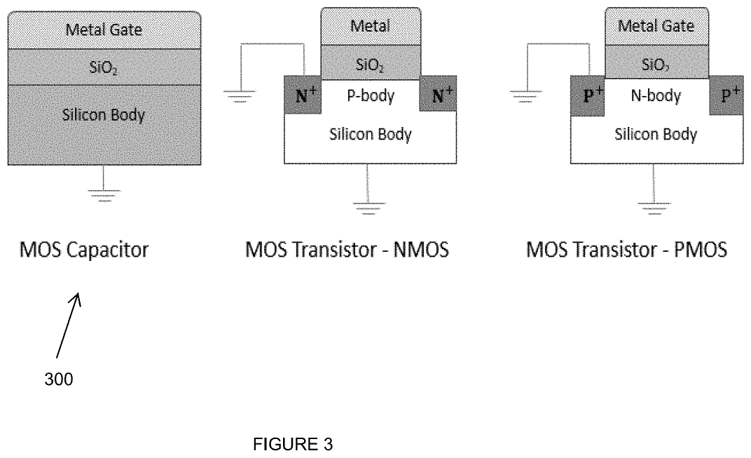

FIG. 3 illustrates an example MOS structure, according to some embodiments.

This can be a MOS capacitor or a MOS transistor.

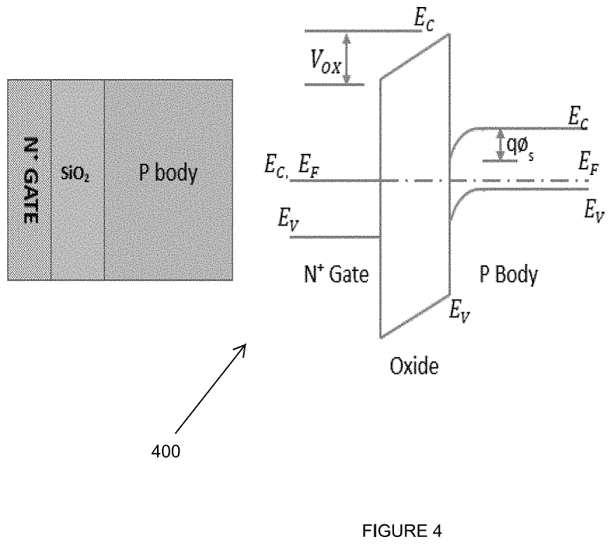

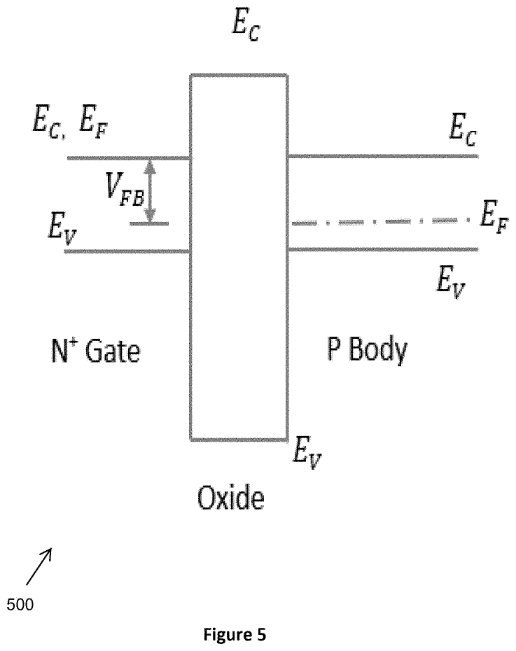

FIG. 4 illustrates an example N⁺P MOS Capacitor, according to some embodiments. As shown, this can be a N⁺P MOS capacitor with its energy band diagram. The MOS capacitor can be made of P-body or P-substrate and N⁺ gate called N⁺P capacitor. It can also be made of P⁺ gate and N-body or N-substrate called P⁺N capacitor. Flat-band is the condition for which the E_{C} and E_{V} of the body is flat at the Si—SiO₂ interface. For a N⁺P MOS structure it is achieved by applying a negative voltage (V_{FB}) to the gate. The flat-band condition energy diagram is shown in FIG. 5. FIG. 5 illustrates an example Flat-Band condition of N⁺P MOS capacitor, according to some embodiments. The operation of MOS capacitor can be as follows. The MOS capacitor operates in one of the following modes: Accumulation mode; Depletion mode; Inversion mode; etc.

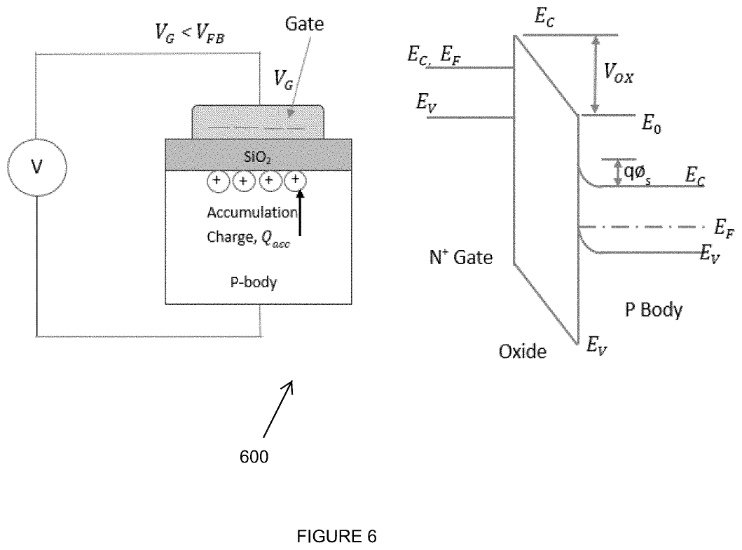

FIG. 6 illustrates an Accumulation Mode example of N⁺P MOS capacitor or N⁺P MOS structure, according to some embodiments. In accumulation mode an N⁺P capacitor like the one shown in Flat-band condition of FIG. 5 can be used. When the voltage applied to the gate (V_{G}) becomes more negative than the flat-band voltage, V_{FB}, then the Si—SiO₂ interface surface voltage, ϕ_{S} and the oxide voltage, Vₒₓ are non-zero. In this condition the valence band energy level, E_{V} is closer to the Fermi energy level, E_{F}, at the surface than in the rest of the body and hence the surface hole concentration p_{S} is larger than the body hole concentration p₀=N_{A}. Surface hole concentration ps can depend on the body doping concentration and the voltage applied to the gate.

p_{S}=N_{A}e^{-qϕ}^{_{S}}^{/kT}

Also, V_{G}=V_{FB}+ϕ_{S}+V_{OX}

Using Gauss's Law, E_{OX}=Q_{acc}/εₒₓ where E_{OX} is the Electric Field in oxide and Q_{acc} is the accumulation charge.

V_{OX}=E_{OX}T_{OX}=−Q_{acc}/C_{OX}

where Tₒₓ and Cₒₓ are Thickness and Capacitance of oxide

Q_{acc}=−C_{OX}V_{OX}

Q_{acc}=C_{OX}(V_{G}−V_{FB}−ϕ_{S})

Therefore the Q_{acc} charge can depend on the surface voltage ϕ_{S} and in turn the surface hole concentration ps which in turn depends on the doping concentration N_{A}.

V_{G} remaining same, changes in N_{A} can give a different Q_{acc}.

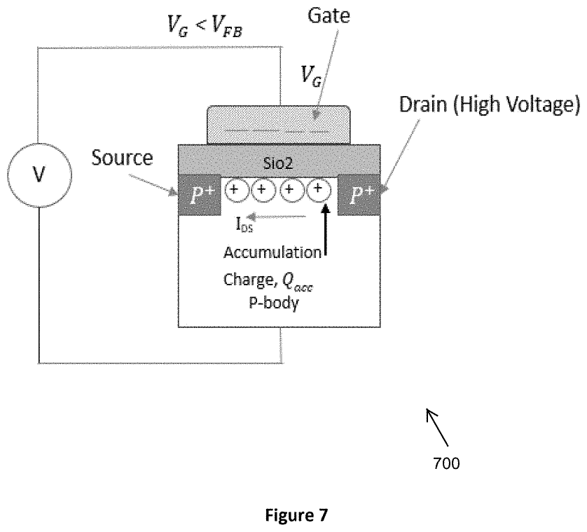

FIG. 7 illustrates an example application of an application for MOS structure with P-body and N_{A} doping, according to some embodiments. If the voltage is applied across the Si—SiO₂ interface as shown in FIG. 7, the current across the surface (e.g. the drain-source current (I_{DS})) can depend on Q_{acc} and in turn the doping level of the body in this case N_{A}. A different N_{A} can have a different I_{DS} with other parameters remaining same.

This theory of different drain-source current (I_{DS}) for different doping levels also applies to MOS structure with N-body and N_{D} doping.

An example MOS structure with N-body and N_{D} doping is discussed.

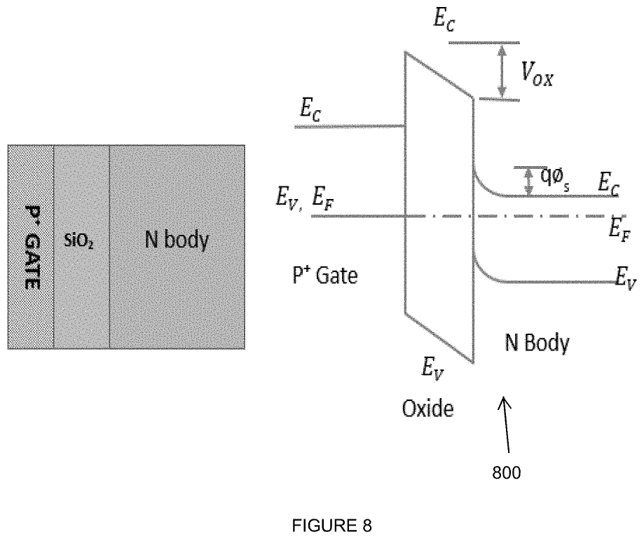

FIG. 8 illustrates an example P⁺N MOS structure. As shown, this can be a P⁺N MOS capacitor with its energy band diagram.

FIG. 9 illustrates the flat-band condition of an example P⁺N MOS structure. For a P⁺N MOS structure it is achieved by applying a positive voltage (V_{FB}) to the gate.

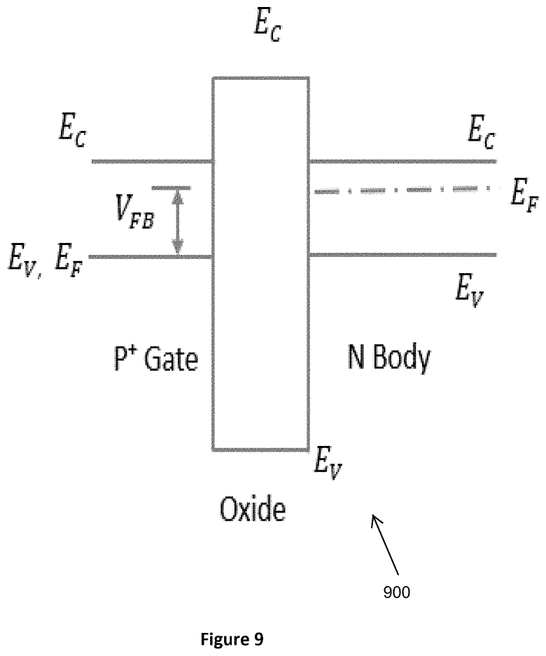

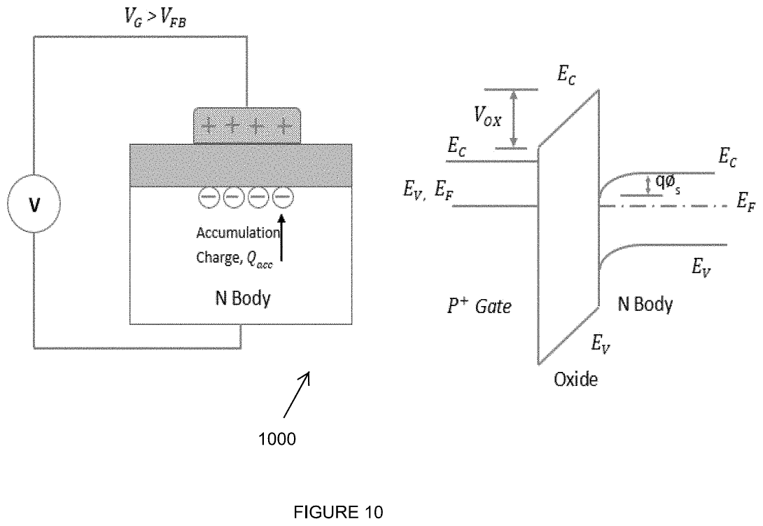

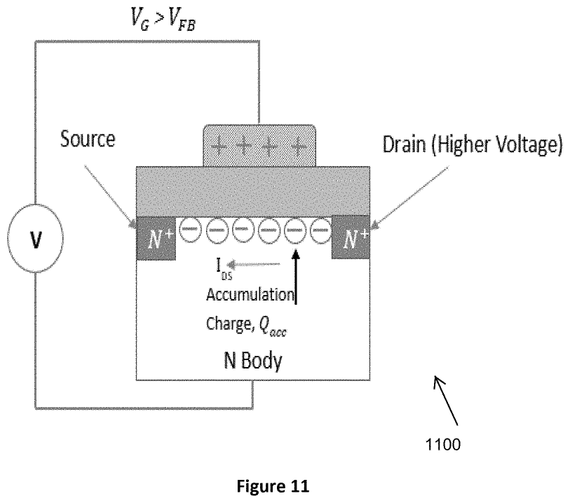

FIG. 10 illustrates an Accumulation Mode example of P⁺N MOS capacitor or P⁺N MOS structure, according to some embodiments. In accumulation mode a P⁺N capacitor like the one shown in Flat-band condition of FIG. 9 can be used. When the voltage applied to the gate (V_{G}) becomes more positive than the flat-band voltage, V_{FB}, then the Si—SiO₂ interface surface voltage, ϕ_{S} and the oxide voltage, Vₒₓ are non-zero. In this condition the conduction band energy level, E_{C} is closer to the Fermi energy level, E_{F}, at the surface than in the rest of the body and hence the surface electron concentration n_{S} is larger than the body hole concentration p₀=N_{D}. The surface electron concentration n_{S} depends on the body doping concentration N_{D} and the voltage applied to the gate.

n_{S}=N_{D}e^{-qϕ}^{_{S}}^{/kT}

Q_{acc}=−Cₒₓ(V_{G}−V_{FB}−ϕ_{S})

Therefore the Q_{acc} charge can depend on the surface voltage ϕ_{S} and in turn the surface electron concentration n_{S} which in turn depends on the doping concentration N_{D}.

V_{G} remaining same, changes in N_{D} can give a different Q_{acc}.

Apart from the accumulation charge Q_{acc} depending on doping concentration, the drift current density can also depend on the doping concentration or carrier concentration.

The drift current density, J_{n,drift} can also depend on the carrier concentration.
J_{n,drift}=qμₙnE=qμₙN_{D}E . . . where n is the carrier concentration, N_{D} in this case; μₙ is mobility of electrons, q is charge of an electron, E is the electric field.

The drift current can therefore be written as:
I_{drift}=qμₙN_{D}E(W*L) . . . where W and L are the width and length of the drain current channel.

The drift current in the MOS capacitor in accumulation mode is same as the drain-source current (I_{DS}). Therefore I_{DS}=qμₙN_{D}E(W*L)

From above, by varying the doping level N_{D}, current I_{DS} may be varied.

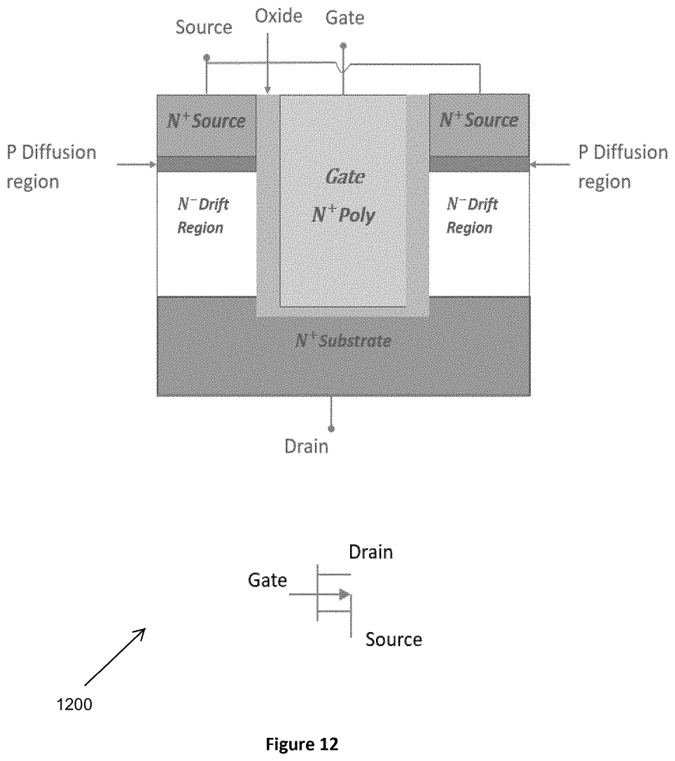

It is noted that varying the drain-source current (I_{DS}) by varying the doping level N_{D}, can work in conjunction with the MOS structure as in FIG. 12. FIG. 12 illustrates an example MOS structure according to some embodiments. The doping concentration of the N⁻ drift region can be varied in the MOS structures to vary the drain-source current (I_{DS}). The proposed structure either singular or plural is used to control the current or applied voltage to the phase shifter attached to the waveguide and in turn control the phase of the waveguide.

An example MOS structure is provided in FIG. 12. The doping concentration of the N⁻ drift region is varied and a different drain-source current (I_{DS}) to gate-source voltage (V_{GS}) or drain-source voltage (V_{DS}) characteristics (I_{DS} Vs. Visor I_{DS} Vs. V_{DS}) is obtained.

It is noted that for MOS structure in FIG. 12, I_{DS} can exist only when V_{GS} is positive, and that the magnitude of I_{DS} can also depend on the magnitude of Vis and Vim apart from the doping concentration of N⁻ drift region. The P diffusion region below the N⁺ source is introduced so that the current flow is only along the trenches.

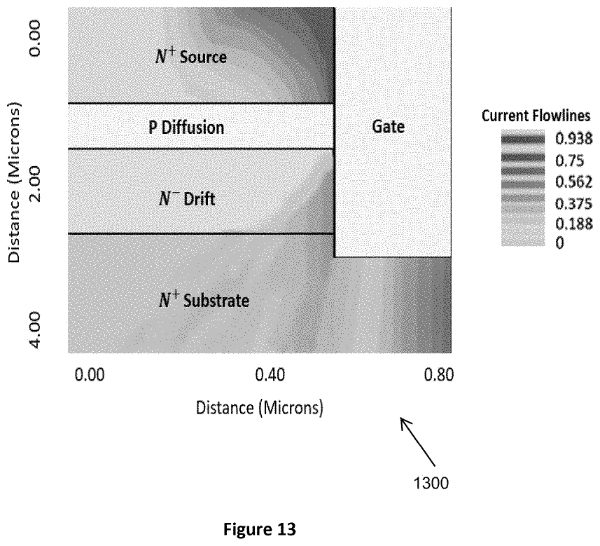

The current flow lines in the MOS structures are shown in FIG. 13. FIG. 13 illustrates an example MOS structure and analytical current flow lines, according to some embodiments.

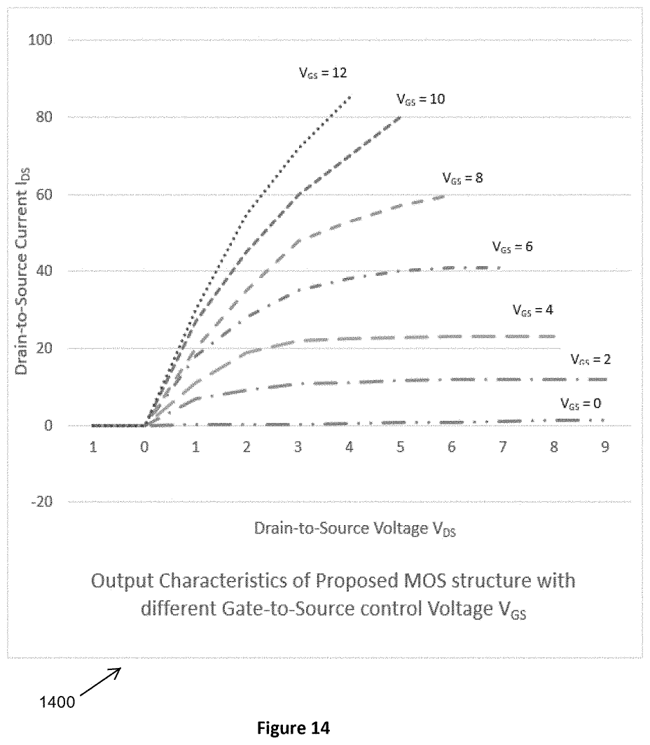

The output characteristics of the proposed structure are plotted in FIG. 14. FIG. 14 illustrates an example MOS structure Darin-to-Source Current I_{DS} and Drain-to-Source Voltage V_{DS} at Different Bias of Control Voltage Gate-to-Source Voltage V_{GS}, according to some embodiments. Multiple such structures with different doping concentration of the N⁻ drift regions are used to control the phase shifter of the waveguide. References shown studies the effect of variation of doping concentration of strained-Silicon/Silicon-Germanium substrate on the capacitance of MOS capacitor. Conductivity and in turn resistivity of silicon for electrons and holes varies with doping concentration. Conductivity is given as σ=q(nμₙ+pμₚ) (Ω⁻¹·cm⁻¹), where μₙ is mobility of electrons, μₚ is mobility of holes, q is charge of an electron, n is electron doping concentration (N_{D}), p is hole doping concentration(N_{A}).

Resistivity ρ=1/σ (Ω·cm).

Drift Current Density according to Ohm's law form is given as J=σE=E/ρ.

Resistivity can vary with doping concentration.

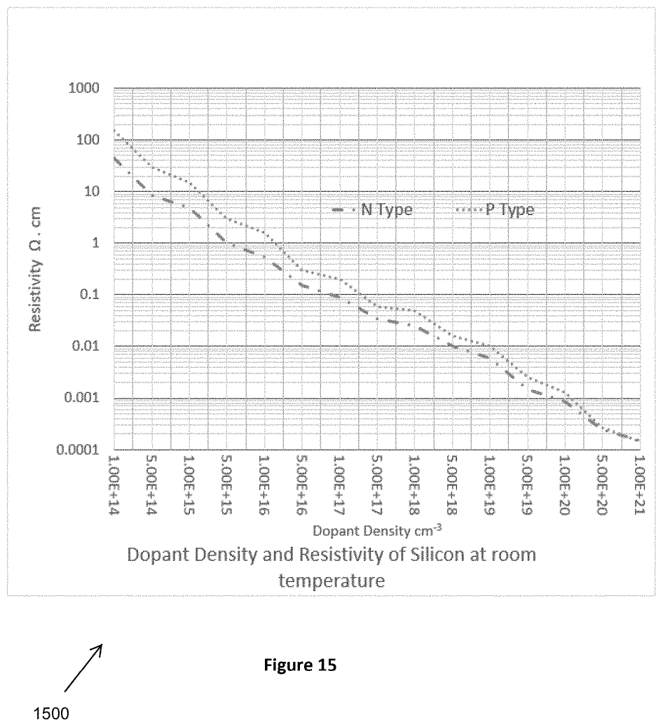

A plot of resistivity of N type semiconductor and P type semiconductor with respect to doping concentration is shown in FIG. 15. FIG. 15 illustrates an example plot showing Dopant Density and Resistivity of Silicon, according to some embodiments

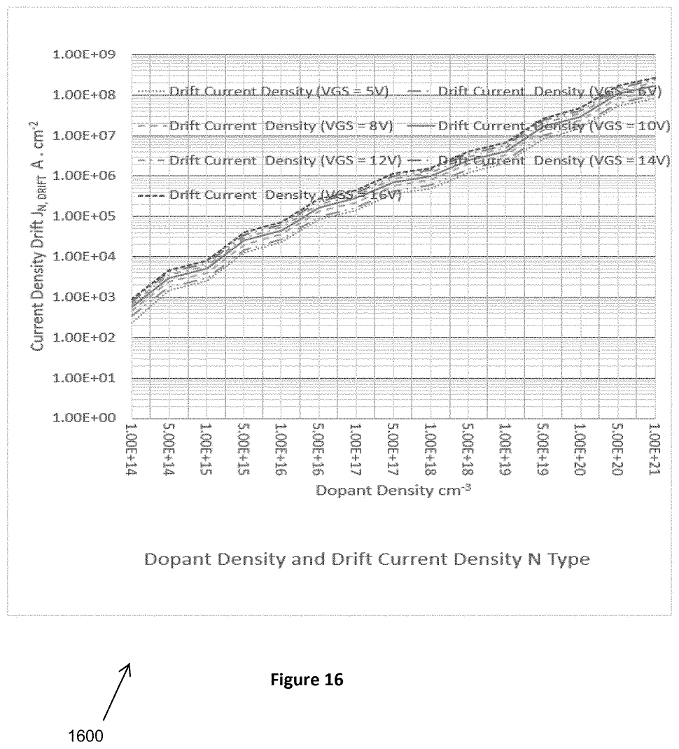

Variation in drift drain-to-source current (I_{DS}) density with different doping concentration for various gate-to-source voltage V_{GS} is shown in FIG. 16. FIG. 16 illustrates an example of Drift Current Density and Dopant Density N type for the MOS structure of FIG. 12, according to some embodiments. The electric field is calculated for a distance of 4 μm. It can be shown that for the same gate-to-source voltage Vis, the drift current density varies according to the doping concentration/density. Also, when the gate-to-source voltage (V_{GS}) changes, the drift drain-to-source current (I_{DS}) density plot shifts.

The fabrication of the MOS structure of FIG. 12 is now discussed. The MOS structure may be fabricated using standard CMOS fabrication techniques. The cell pitch of the MOS structure may be made as small as possible provided the fabrication technology supports the size. The structure may be fabricated using a six-mask process with a 2.5 μm epitaxial layers grown on 0.002 Ω·cm arsenic doped structures. The N⁺ source region may be formed using a 30 keV phosphorus implant with the dose that depends on the doping level concentration of N⁻ drift region and the dose is driven to obtain a depth of 0.5 μm. The gate trenches may be of 3 μm deep and a gate oxide of 70 nm may be grown before depositing the polysilicon gate electrode. The substrate layer may be 1 μm thick. The drift region thickness may be around 2.5 μm as the breakdown voltage reduces dramatically if the drift region thickness is reduced below 2.2 μm.

Fabrication of the MOS structure is not limited to the above method and in general the claim covers any other available fabrication technique that may be used to fabricate the MOS structure. The dimensions are provided by way of example and in general covers the cases, where the dimensions of the MOS structure may change and dimensions are not limited to the one listed above and may change as the fabrication techniques change and evolve.

The use of MOS structure of FIG. 12 is now discussed. The MOS structure of FIG. 12 can be used in steering the beam by controlling the phase of the signal through the waveguide. As explained above, in legacy systems there can be almost N control signals to control the phase of N waveguides. This in turn can use N DAC's and their auxiliary circuits making the system bulky and costly. Also, tracking N control signals is computationally intensive and can use lot of computation resources. Beam steering with only one control signal can be implemented. Beam steering with only one control signal is thus cost effective and less bulky. Also, since the control is through MOS structure within the same integrated circuit (IC), the beam can be steered extremely fast as the propagation delay with latest MOS structures is of sub-nanosecond order. Also, the power consumed by MOS structures is negligible when compared with conventional structures of resistors and capacitors. The resistance to turn on drain-to-source current, I_{DS} is given by the following equation:

R=(L*W)/(μₐ*C_{OX}*V_{GS})

Where R is the resistance,

L is channel length,

W is width of MOS structure,

μₐ is accumulation layer mobility,

C_{OX} is the oxide capacitance per square centimeter,

V_{GS} is the gate-to-source voltage,

Therefore, with a channel length of 2 μm, width of 3 μm, C_{OX} of 49.3 nF/cm² for oxide thickness of 700° A, mobility μₐ of 1000 cm²/V·s and V_{GS} of 15 V, resistance R=90 μΩ·cm² can be obtained. This specific “ON” resistance is extremely low when compared with conventional voltage divider, resistor, and capacitor circuits where resistance can be multifold times higher (^{˜}10⁶ times). Therefore, many such MOS structures can be supported by a single control voltage and in turn control many phase shifters and achieve beam steering using just one control signal. The “ON” resistance of this trench MOS structure of FIG. 12 is also lower than the planar MOS structure having typical resistance of 1.56 mΩ·cm².

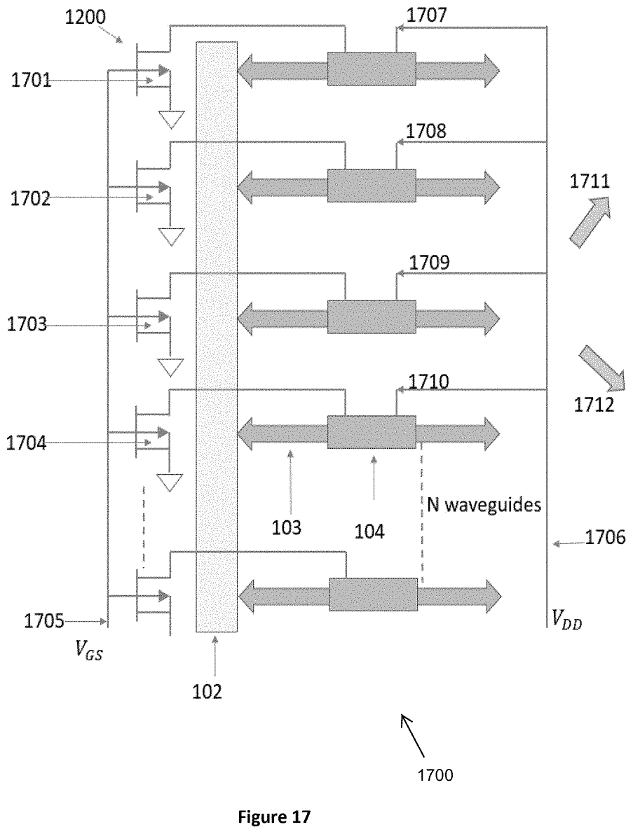

FIG. 17 illustrates a use of MOS structure to achieve beam steering, according to some embodiments. As shown are four waveguides 103 along with four phase shifters 104. Waveguides 103 are connected to laser transmitter and receiver 102. MOS structure 1200 can be the MOS structure of FIG. 12 described supra. Here gate-to-source voltage V_{GS} 1705 is used as the control signal. The drain-to-source voltage V_{DS} is represented by 1706 and is set to V_{DD}, the power supply voltage. 1701-1704 represent different doping profiles of N⁻ drift region of the MOS structure of FIG. 12. For example, 1701 may be 1*10¹⁵ cm⁻³, 1702 may be 5*10¹⁵ cm⁻³, 1703 may be 1*10¹⁶ cm⁻³ and 1704 may be 5*10¹⁶ cm⁻³. The different drain-to-source currents (I_{DS}) through the phase shifters 104 are represented by 1707, 1708, 1709 and 1710. With different drain currents, the phase can be shifted differently by the phase shifters 104 and the beam can be steered in the air in some direction say 1711. When the control signal 1705 changes, the drain-to-source currents (I_{DS}) 1707 to 1710 can also change and with this change the phase shifted by the phase shifters 104 can also change and the beam thus the beam can be steered in some other direction say 1712.

In general, there may be a plural number of waveguides along with their phase shifters forming the phased array and the waveguides may be arranged to form a one-dimensional phased array or two-dimensional phased array. Also, the drain-to-source voltage V_{DS} may be used as control signal instead of gate-to-source voltage Vis.

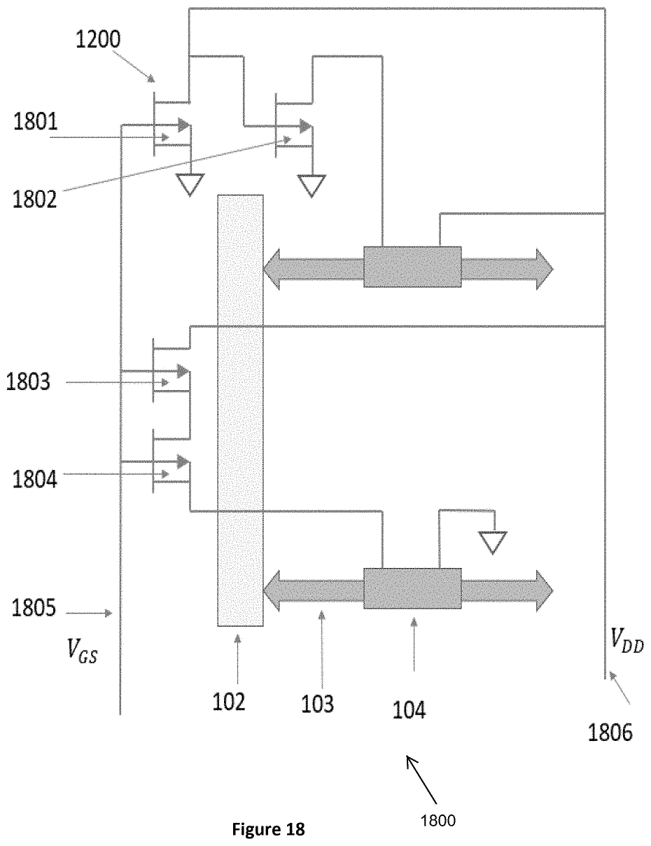

The MOS structures of FIG. 12 can also be used in cascaded fashion to achieve the desired phase shifting. FIG. 18 illustrates an example use of MOS structure of FIG. 12 to achieve beam steering, according to some embodiments. FIG. 18 shows the use of the MOS structure of FIG. 12 in cascaded fashion. Doping levels 1801 and 1802 of N⁻ drift region form one cascading unit which controls the phase. Doping levels 1801 and 1802 may be same or different. Similarly, cascading unit 1803 and 1804 controls the phase. Here gate-to-source voltage Vis 1805 is used as the control signal. The drain-to-source voltage V_{DS} is represented by 1806 and is set to V_{DD}, the power supply voltage. Cascading unit 1803 and 1804 shows two elements, but can be any number with a combination of doping levels.

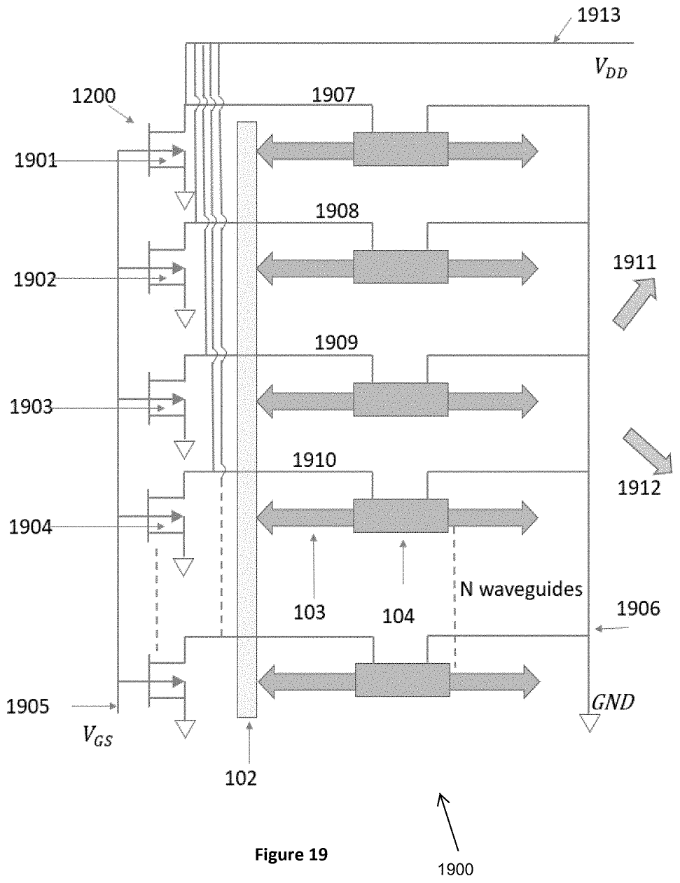

FIG. 19 illustrates an example use of MOS structure of FIG. 12 to achieve beam steering, according to some embodiment. As shown, the MOS structure of FIG. 12 can be used to control the phase shifter by applying the voltage instead of controlling the phase shifter by use of drain-to-source current (I_{DS}) as demonstrated in FIG. 17. In the present example, there are four waveguides 103 along with four phase shifters 104. Waveguides 103 are connected to Laser transmitter and receiver 102. MOS structure 1200 is also provided. Here gate-to-source voltage V_{GS} 1905 can be used as the control signal. The drain-to-source voltage V_{DS} 1913 can be set to V_{DD}, the power supply voltage. Ground terminal 1906 is provided.

Different doping profiles 1901-1904 of N⁻ drift region of the MOS structure are also provided. For example, 1901 may be 1*10¹⁵ cm⁻³, 1902 may be 5*10¹⁵ cm⁻³, 1903 may be 1*10¹⁶ cm⁻³ and 1904 may be 5*10¹⁶ cm⁻³. The different voltages applied to the phase shifters 104 are represented by 1907, 1908, 1909 and 1910. With different voltages applied to the phase shifters 104, the phase can be shifted differently by the phase shifters 104 and the beam can be steered in the air in a specified direction 1911. When the control signal 1905 changes, the voltages 1907 to 1910 applied to the phase shifters 104 can also change and with this change the phase shifted by the phase shifters 104 can also change and thus the beam can be steered in some other direction say 1912.

The use of the MOS structure of FIG. 12 is not limited to FIG. 17, FIG. 18, and FIG. 19 (provided by way of example) and that the MOS structure of FIG. 12 may be used in multiple ways to achieve the desired beam steering. In this way, the described systems can achieve beam steering with just one control signal by using the MOS structure of FIG. 12 with various doping concentration of N⁻ drift regions.

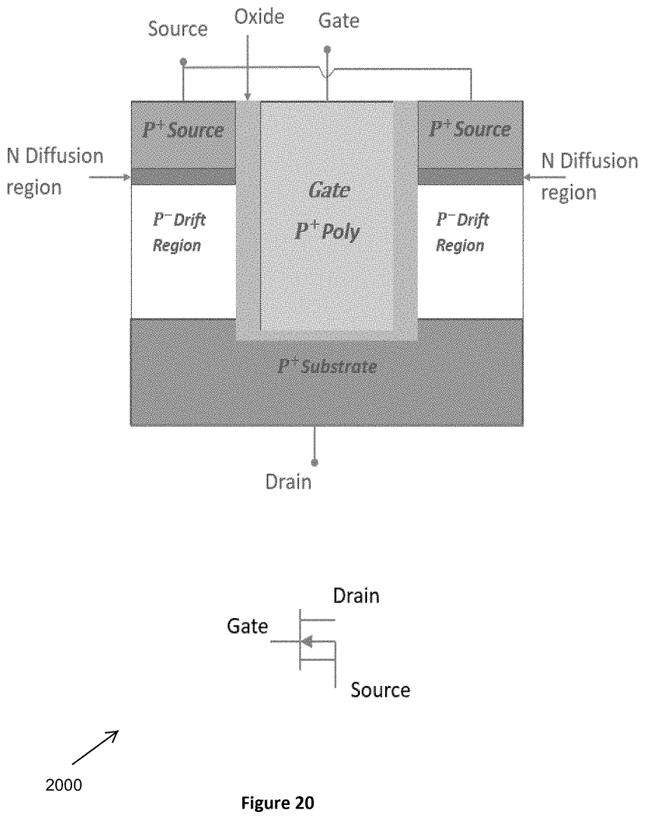

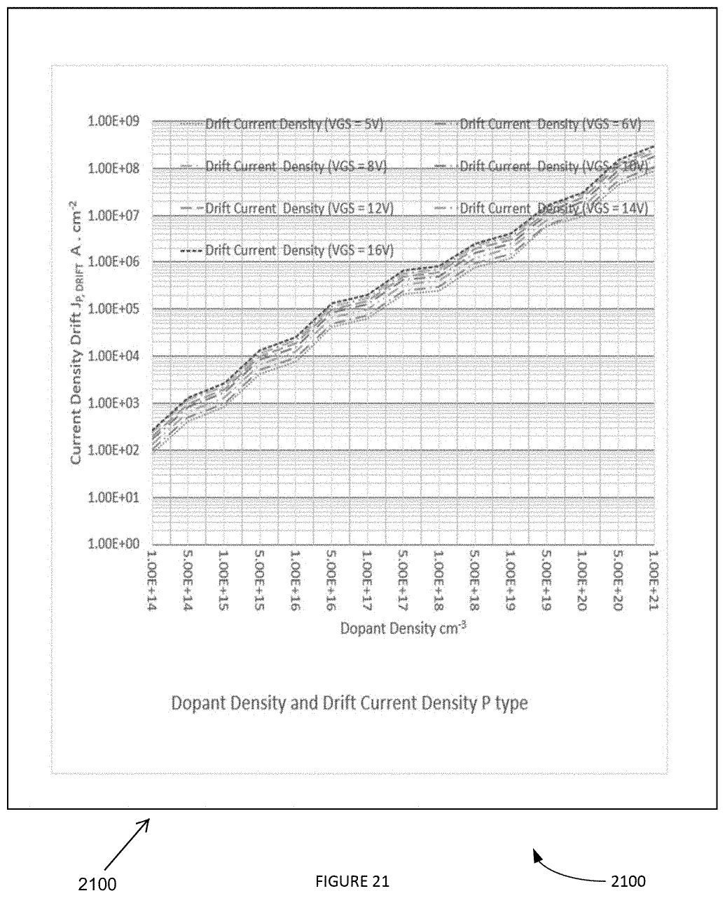

An alternative MOS structure to the MOS structure of FIG. 12 can also be used as shown in FIG. 20. FIG. 20 illustrates an example alternative MOS structure, according to some embodiments. Here the drain-to-source current (I_{DS}) channel is formed by holes instead of electrons. FIG. 21. FIG. 21 illustrates an example, drift current density and dopant density P type, according to some embodiments. FIG. 21 shows the variation in drift drain-to-source current (I_{DS}) density as the doping concentration changes for the alternative MOS structure of FIG. 20. When the gate-to-source (V_{GS}) voltage changes the plot of drift drain-to-source current (I_{DS}) density versus the doping concentration shifts.

It is noted that the accumulation mode of the proposed structures can be used to achieve beam steering. One may in general also use inversion mode of the MOS structure to achieve beam steering. Example embodiments are not limited to doping concentration variation of the drift region alone. In some cases, the doping concentration of source and/or drain and/or substrate and/or diffusion region may be altered to achieve similar effect in various example embodiments. Example embodiments are not limited to doping concentration variation. In some cases, thickness and/or doping concentration of the drift region and/or substrate and/or diffusion region may be altered to achieve similar effect in various example embodiments.

In some examples, waveguides can carry the transmitted as well as received signal. This use of waveguides is shown only for the purpose of demonstration and is not limited to this specific case. Beam steering can be achieved using phase shifters. It is noted that example embodiments can be applied when phase shifters are used to achieve beam steering. Examples can be used when phase shifters are used to achieve beam steering. In some cases, an individual waveguide may carry signal in only one direction, either transmitted or received signal. In some examples, only a fraction of total number of waveguides may carry signal in both direction while the remaining waveguides may carry signal only in one direction.

Examples can be used to achieve the steering of electromagnetic optical signal. This can be used to steer any electromagnetic signal such as those used in Radar (Radio detection and ranging). The same principle as demonstrated over here may be used to shift phase in waveguides carrying radar signal.

Field Programmable Phase Controller Device

An example embodiment provides a field programmable device to control the beam steering of electromagnetic wave by a single control signal. The field programmable device contains MOS structures that control the phase of the electromagnetic signal traversing through the waveguides or antennas. The field programmable device contains multiple such MOS structures with various doping levels that in turn control the current through the phase shifter and thus the phase of the electromagnetic signal traversing through the waveguides or antennas to which the phase shifter is attached. In some other embodiments the waveguides or antennas themselves behave as phase shifters. The outputs from the field programmable device are given to the phase shifters to achieve phase control and beam steering. The connection from the various MOS structures to the output is field programmable. Also, the interconnection between the MOS structures is field programmable. Thus, the field programmable device can be programmed so that the various MOS structures can be arranged in some particular way and then connected to the output terminals so that when the output terminals are connected to the phase shifters of the waveguides or antennas, the beam gets steered by a single control signal.

Beam steering is a component of Lidar (light detection and ranging) and/or Radar (radio detection and ranging). If one intends to have chip-based Lidar or Radar, beam steering system can be utilized. One would then want a very compact, cost effective and less power consuming beam steering system and that too one that can be fabricated using the prevailing and matured complimentary metal-oxide-semiconductor CMOS fabrication process. Accordingly, a beam steering system can be tested before giving the design for fabrication. Example embodiments can have a capability to re-program the beam steering system in the eventuality of some problematic issue or for any other reason when the Lidar or Radar has already been deployed in the field.

The field programmable phase controlling device includes an input terminal to which the beam steering control signal may be connected. This control signal may come from some external controller and it is used to steer the beam. The field programmable phase controlling device includes multiple MOS structures of FIG. 12 and FIG. 20. The MOS structures in the field programmable phase controlling device have different doping concentration of the N⁻ or P⁻ drift regions depending on whether MOS structures of FIG. 12 or MOS structures of FIG. 20 are used. Multiple copies of same doping concentration of N⁻ or P⁻ drift regions may also exist. Also, there are plural number of output terminals. These output terminals may be connected to the phase shifters. The phase shifters may be external to the field programmable device. The field programmable phase controlling device may provide power to the external phase shifters. The phase shifters may use the power provided by the field programmable device or have their power delivered from some other external part, provided the power ratings of the external power delivery part are within the voltage regulation limits of the field programmable phase controlling device.

Each phase shifter is attached to a waveguide or to an antenna. The phase shifters are used to vary the phase of the electromagnetic signal in the waveguide or the antenna. The waveguides or the antennas are physically arranged to achieve beam steering of the signal propagating out of them and into the air. One such arrangement is to have a physical separation of half wavelength of the propagating signal between adjacent waveguides or antennas. In this arrangement, when the signal propagates in the air from the waveguide or the antenna, there is either constructive superimposition or destructive superimposition of the signal in the vicinity of the waveguides or the antennas. The phase of the signal in the waveguides or antennas decide where constructive superimposition or destructive superimposition will occur. The signal propagates where there is constructive superimposition. There will be no propagation of the signal where there is destructive superimposition. Thus, depending on the phase, the signal beam steering occurs.

The phase is controlled by the magnitude of current through the phase shifter or the voltage applied to the phase shifter. This magnitude depends on the MOS structures attached to the phase shifter. The control signal that may be connected to the input terminal may be used as gate-source voltage, Vis of MOS structures. The magnitude of the control signal gate-source voltage Vis is same across the field programmable phase controlling device. The doping concentration of the drift region of the MOS structures then decide the difference in magnitude of the current or voltage given to the phase shifters. Thus, the phase of the phase shifters is controlled by the doping concentration of the drift region of the MOS structures. When the magnitude of the control signal gate-source voltage V_{GS} changes, the magnitude of the current or voltage given to the phase shifters also changes. Thus, the phase of the phase shifters is also controlled by the magnitude of the control signal gate-source voltage V_{GS}.

The phase of the phase shifters is controlled by the doping concentration and the magnitude of the control signal gate-source voltage V_{GS}.

Once the field programmable phase controlling device is programmed, when the magnitude of the control signal changes, the current or voltage given to the phase shifter changes and hence the phase of the signal also changes, and this leads to change in the direction of electromagnetic signal propagating out of waveguides or antennas and thus the beam gets steered in different direction.

The field programmable phase controlling device is capable of the following programming operations:
programming the connection of the gate terminal of the MOS structure to a gate-source voltage V_{GS} or a source terminal of some other MOS structure or a drain terminal of some other MOS structure or to leave the gate terminal floating.
programming the connection of the drain terminal of the MOS structure to a drain-source voltage V_{DS} or a gate terminal of some other MOS structure or a source terminal of some other MOS structure or an unoccupied output terminal or to leave the drain terminal floating.
programming the connection of the source terminal of the MOS structure to a gate terminal of some other MOS structure or a drain terminal of some other MOS structure or an unoccupied output terminal or to leave the drain terminal floating.

If any of the terminal of the MOS structure is floating, then this MOS structure is not part of the final programmed circuit and does not contribute to any output.

The interconnections between the MOS structures are now discussed. The interconnections can be between MOS structures of same doping concentrations, or the interconnections can be between MOS structures different doping concentrations, or the interconnections can be between MOS structures of similar types, e.g. either interconnections between MOS structures of FIG. 12 or interconnections between MOS structures of FIG. 20, or the interconnections can be between MOS structures of different types, e.g. interconnections between MOS structures of FIG. 12 and FIG. 20).

The proposed field programmable phase controller (FPPC) device has similarity with the features of field programmable gated array (FPGA) device. Those with familiarity in the field can identify that the interconnections between various gates in the FPGA device are programmed to achieve a task. On similar lines, the interconnections between the MOS structures are programmable in the field programmable phase controller (FPPC) device.

An example embodiment programming of the field programmable phase controller (FPPC) device establishes the interconnections between the MOS structures and the connection between MOS structures and the output. The input to the device is the control signal from the Lidar or Radar control unit or some other external controller. This input control signal is used as gate-to-source voltage Vis in the device. When the example embodiment programming of the field programmable phase controller (FPPC) device is complete, changes in the magnitude of the control signal gate-source voltage Vis, changes the direction of electromagnetic signal propagating out of waveguides or antennas and thus beam steering is achieved.

### CONCLUSION

Although the present embodiments have been described with reference to specific example embodiments, various modifications and changes can be made to these embodiments without departing from the broader spirit and scope of the various embodiments.

What is claimed:

1. A metal-oxide semiconductor (MOS) structure to achieve a beam steering, comprising:
a n-number of waveguides, wherein the n-number of waveguides are connected to a laser transmitter and a receiver;
a n-number phase shifters;
wherein the MOS structure comprises a doping concentration of an N-drift region that is varied and a different drain-source current (I_{DS}) to gate-source voltage (V_{GS}) or drain-source voltage (V_{DS}) characteristics are obtained, and wherein the I_{DS} exists when the V_{GS} is positive, and a magnitude of the I_{DS} depends on a magnitude of the V_{GS} and the V_{DS} apart from the doping concentration of N− drift region,
wherein the n-number of waveguides are connected to a laser transmitter and a receiver device,
wherein the V_{GS} is used as a control signal,
wherein the V_{DS} is set to a power supply voltage (V_{DD}) based on at least one doping profile of the N⁻drift region of the MOS structure,
wherein a plurality of different drain-to-source currents (I_{DS}) are provided through the n-number of phase shifters, and
wherein with a set of specified drain currents (I_{DS}), a phase is shifted differently by the n-number of phase shifters and the beam is steered in a specified direction, and
wherein only one control signal is used to achieve beam steering.

2. The MOS structure of claim 1, wherein the n-number of waveguides comprises four waveguides.

3. The MOS structure of claim 1, wherein the n-number of phase shifters comprises four phase shifters.

4. The MOS structure of claim 1, wherein a P-diffusion region of the MOS structure below an N⁺ source is introduced so that a current flow is only along one or more trenches of the MOS structure.

5. The MOS structure of claim 1, wherein when the control signal is modified, the drain-to-source current also changes and with this change the phase shifted by the n-number phase shifters is modified and the beam steered in a specified direction.

6. The MOS structure of claim 1, wherein the MOS structure is used in a cascaded fashion to achieve a desired phase shifting.

7. The MOS structure of claim 6, wherein a doping level of the N− drift region forms one cascading unit which controls the phase.

8. The MOS structure of claim 7, wherein a set of doping levels are each identical.

9. The MOS structure of claim 7, wherein the set of doping levels are each different.

10. The MOS structure of claim 7, wherein the V_{GS} is used as the control signal.

11. The MOS structure of claim 10, wherein the V_{DS} is represented is set to a power supply voltage (V_{DD}) of a cascading unit.

12. The MOS structure of claim 11, wherein the cascading unit comprises a combination of doping levels.

13. The MOS structure of claim 1 wherein Vis is used as the control signal.

14. The MOS structure of claim 13, wherein the V_{DS} set to V_{DD} and a ground terminal is provided.

15. The MOS structure of claim 14, a set of different doping profiles of the N− drift region of the MOS structure are also provided.

16. The MOS structure of claim 15, wherein set of different doping profiles comprises a 1*10¹⁵ cm⁻³ doping profile.

17. The MOS structure of claim 15, wherein set of different doping profiles comprises a 5*10¹⁵ cm⁻³ doping profile.

18. The MOS structure of claim 15, wherein set of different doping profiles comprises a 1*10¹⁶ cm⁻³ doping profile.

19. The MOS structure of claim 15, wherein set of different doping profiles comprises a 5*10¹⁶ cm⁻³ doping profile.

20. The MOS structure of claim 15,
wherein with a set of different voltages applied to the phase shifters the phase is shifted differently by the n-number phase shifters and the beam steered in a specified direction,
when the control signal changes, one or more voltages applied to the n-number phase shifters is changed and the phase shifted by the n-number of phase shifters such that the beam steered in a specified direction, and
wherein the beam comprises a LIDAR or a RADAR beam.
